(19) United States
(12) Patent Application Publication
(10) Pub. No.: US 2025/0217254 A1
(43) Pub. Date: Jul. 3, 2025

(54) REINFORCEMENT LEARNING-BASED SYSTEM AND ADAPTIVE CONTROL METHOD THEREOF

(71) Applicant: MEDIATEK INC., Hsinchu City (TW)

(72) Inventors: Nien-Hsien LIN, Hsinchu City (TW); Cheng-Kuan HOH, Hsinchu City (TW); Yen-An SHIH, Hsinchu City (TW); Wei-Shuo CHEN, Hsinchu City (TW); Cheng-Han TSAI, Hsinchu City (TW); Cheng-Che CHEN, Hsinchu City (TW)

(21) Appl. No.: 18/398,337

(22) Filed: Dec. 28, 2023

(51) Int. Cl. G06F 11/34

(52) U.S. Cl. CPC G06F 11/3409

(57) ABSTRACT

A reinforcement learning-based system for adaptively controlling computing performance is provided. The system includes an environment module and an agent module. The environment module is configured to collect environment information from the application environment. Based on the collected environment information, the environment module calculates a reward value using a reward function and then outputs the state data and the reward value to the agent module. The agent module receives the output from the environment module, including the reward value and the state data. Based on the received reward value and state data, the agent module determines a performance adjustment action to take, which is then fed back to the application environment. Upon receiving the performance adjustment action, the application environment executes the performance adjustment operation in response, causing the environment module to collect the updated environment information as a result of the performance adjustment operation.

### BACKGROUND OF THE INVENTION

### Field of the Invention

The present disclosure relates to the techniques of reinforcement learning and adaptive control, and in particular to a reinforcement learning-based system for adaptively controlling computing performance.

### Description of the Related Art

Balancing computational performance to meet user demand while minimizing power consumption is a key objective for manufacturers of computing devices, such as computers, smart phones, tablets, servers, gaming consoles, etc. Attaining this goal necessitates meticulous management of diverse system resources, including various processing units and memory units. Each resource-related module may employ independent or interdependent algorithms that rely on specific indicators to ensure the resources' capabilities satisfy the demands of applications, such as games, simulations, data analytics, machine learning, video editing, 3D rendering, etc. Additionally, these algorithms often produce numerous parameters that typically require manual tuning and customization for specific applications.

Besides efficiency concerns, the limitations of manual parameter tuning are further evident in applications with rapidly changing performance requirements. For instance, in games, different scenes (e.g., character locations on maps) may have varying performance requirements, leading to fluctuations in performance when transitioning between scenes. Additionally, many performance-affecting features may be too implicit or complex for humans to comprehend, such as interactions between multiple parameters. Conventional computer-implemented solutions still require humans to provide rule-based approaches based on accumulated experience and induction, so they may not achieve effective adaptability in controlling computing performance.

Therefore, there is a need for a reinforcement learning (RL)-based system for adaptively controlling computing performance.

### BRIEF SUMMARY OF THE INVENTION

An embodiment of the present disclosure provides a reinforcement learning-based system for adaptively controlling computing performance. The system includes an environment module and an agent module. The environment module is configured to collect environment information including target frame speed, actual frame speed, and actual performance from an application environment. The environment module is further configured to calculate a reward value using a reward function based on the target frame speed and the actual frame speed. The environment module is further configured to output the reward value and the state data that includes the actual frame speed and the actual performance. The agent module is configured to receive the reward value and the state data output from the environment module. The agent module is further configured to determine the step size based on the reward value. The agent module is further configured to determine a performance adjustment action to take based on the step size. Additionally, the application environment executes a performance adjustment operation in response to the performance adjustment action. Furthermore, the actual frame speed includes one or both of an actual frame rate and an actual frame time, and the target frame speed includes one or both of a target frame rate and a target frame time.

In an embodiment, the agent module determines the step size through optimizing a learning rate based on the reward value and calculating the step size based on the learning rate, the target frame speed, and the actual frame speed.

In an embodiment, the agent module determines the step size through multiplying the learning rate by a first discrepancy between the target frame time and the actual frame time.

In an embodiment, the reward function uses a distance measure to evaluate the discrepancy between the target frame rate and the actual frame rate. In a further embodiment, the distance measure is absolute distance.

In an embodiment, the performance adjustment operation includes adjusting computing performance through setting a new target frame speed. In a further embodiment, the performance adjustment action is associated with the target frame speed. Additionally, the agent module is further configured to calculate the new target frame speed through incrementing the target frame speed by the step size. In another further embodiment, the performance adjustment action is associated with a target performance level. Additionally, the agent module is further configured to calculate the target performance level through multiplying the actual performance by the step size, and to determine the new target frame speed through looking up a mapping table that records mappings between the target performance level and the target frame speed.

In an embodiment, the environment module collects the actual frame speed through application programming interface provided by the operating system.

In an embodiment, the environment module collects the actual performance through shell scripts or application programming interface provided by the operating system.

An embodiment of the present disclosure provides an adaptive control method, for use in a reinforcement learning-based system comprising an environment module and an agent module. The method includes the following steps. The environment module collects environment information including target frame speed, actual frame speed, and actual performance from an application environment. The environment module calculates a reward value using a reward function based on the target frame speed and the actual frame speed. The environment module outputs the reward value and the state data to the agent module. The actual frame speed includes one or both of an actual frame rate and an actual frame time, and the target frame speed includes one or both of a target frame rate and a target frame time. The method further includes the following steps. The agent module receives the reward value and the state data output from the environment module. The agent module determines the step size based on the reward value. The agent module determines the performance adjustment action to take based on the step size. Furthermore, the application environment executes a performance adjustment operation in response to the performance adjustment action.

In an embodiment, the step of determining the step size includes optimizing the learning rate based on the reward value, and calculating the step size based on the learning rate, the target frame speed, and the actual frame speed.

In an embodiment, the step of determining the step size further includes multiplying the learning rate by a first discrepancy between the target frame time and the actual frame time.

In an embodiment, the performance adjustment operation includes adjusting computing performance through setting a new target frame speed. In a further embodiment, the performance adjustment action is associated with the target frame speed. Additionally, the method further includes the following steps. The agent module calculates the new target frame speed through multiplying the target frame speed by the step size. In another further embodiment, the performance adjustment action is associated with a target performance level. Additionally, the method further includes the following steps. The agent module calculates the target performance level through incrementing the actual performance by the step size. The agent module determines the new target frame speed through looking up a mapping table that records mappings between the target performance level and the target frame speed.

The RL-based adaptive control techniques provided in the present disclosure offers several benefits for computing performance optimization. Firstly, it enables adaptability by continuously adjusting the system's performance based on changing conditions and requirements. Secondly, it empowers the system to make autonomous decisions without relying on predefined rules or manual intervention, leading to more efficient and effective control. Thirdly, the system can optimize its performance by exploring different strategies and configurations, finding the best approach for a given task. Additionally, the learned policies can generalize to handle various workloads and scenarios, making the system versatile and responsive in diverse environments. Moreover, the continuous learning capability allows the system to improve its performance control over time. Overall, embodiments of the present disclosure provide intelligent and dynamic computing performance control in a changing computing environment.

### BRIEF DESCRIPTION OF THE DRAWINGS

The present disclosure can be more fully understood by reading the subsequent detailed description and examples with references made to the accompanying drawings. Additionally, it should be appreciated that in the flow diagram of the present disclosure, the order of execution for each blocks can be changed, and/or some of the blocks can be changed, eliminated, or combined.

FIG. 1 is the schematic diagram illustrating a reinforcement learning-based system for adaptively controlling computing performance, according to an embodiment of the present disclosure.

FIG. 2A is the flow diagram illustrating the steps for the environment module, according to an embodiment of the present disclosure.

FIG. 2B is the flow diagram illustrating the steps for the agent module, according to an embodiment of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

In each of the following embodiments, the same reference numbers represent identical or similar elements or components.

Ordinal terms used in the claims, such as “first,” “second,” “third,” etc., are only for convenience of explanation, and do not imply any precedence relation between one another.

The description for the embodiments of the method is also applicable to the embodiments of the device or system, and vice versa.

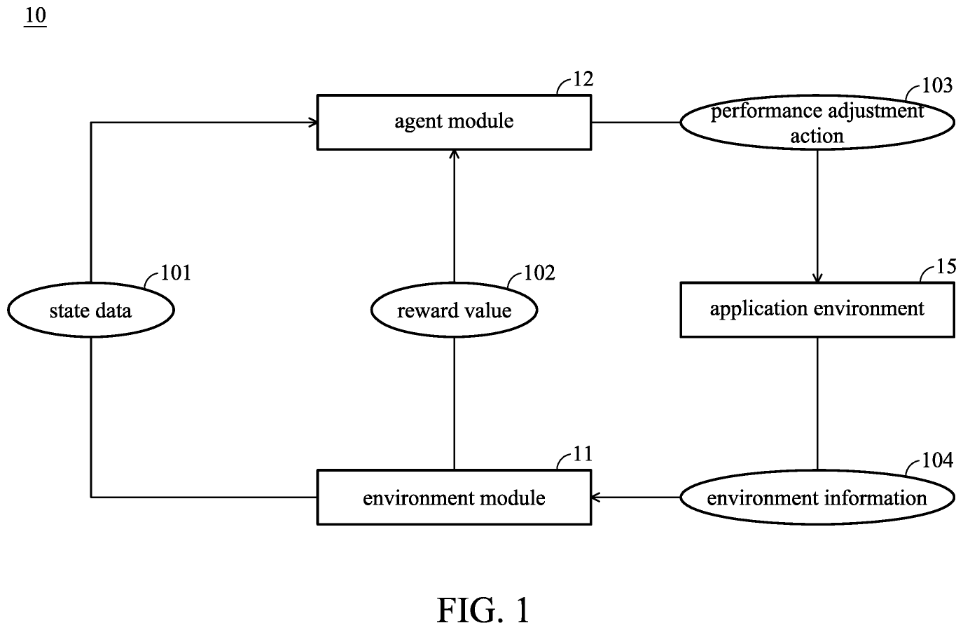

FIG. 1 is the schematic diagram illustrating a reinforcement learning-based system 10 for adaptively controlling computing performance, according to an embodiment of the present disclosure. As shown in FIG. 1, the system 10 includes the environment module 11 and the agent module 12. Additionally, FIG. 1 further shows the interactions between an application environment 15 with the environment module 11 and the agent module 12. The application environment 15 can be regarded as being included in the system 10, or being external to the system 10, the present disclosure is not limited thereto.

The system 10 may be implemented using either general-purpose processing units or special-purpose hardware circuitry. In an embodiment, the system 10 can be a general-purpose processor, a microprocessor, or a microcontroller that loads a program or an instruction set from the electronic device's storage unit (including both volatile and non-volatile memories) to carry out the functions of the environment module 11 and the agent module 12. In another embodiment, the system 10 may include one or more integrated circuits, such as system-on-chip (SoC), application-specific integrated circuits (ASICs) and/or field programmable gate arrays (FPGAs) that are dedicated to implementing the environment module 11 and the agent module 12.

The application environment 15 refers to the collection of software, hardware, and configuration settings in which an application (e.g., games, simulations, data analytics, machine learning, video editing, 3D rendering, etc.) operates. The application environment 15 may involve computing resources and dependencies required to run the application effectively and efficiently, such as processing units (e.g., CPU, GPU, TPU, NPU, etc.), memory units (e.g., RAM, ROM, DRAM, SRAM, flash memories, etc.), BIOS, operating systems (e.g., Windows, Mac OS, Linux, UNIX, etc.), runtime environment (e.g., Java virtual machine, Node.js, .NET Framework, etc.), database, networking resources, security settings and configuration settings.

The environment module 11 is configured to collect environment information 104 from the application environment 15. Based on the collected environment information 104, the environment module 11 calculates a reward value 102 using a reward function and then outputs the state data 101 and the reward value 102 to the agent module 12. The agent module 12 receives the output from the environment module 11, including the reward value 102 and the state data 101. Based on the received reward value 102 and state data 101, the agent module 12 determines a performance adjustment action 103 to take, which is then fed back to the application environment 15. Upon receiving the performance adjustment action 103, the application environment 15 executes the performance adjustment operation in response, causing the environment module 11 to collect the updated environment information 104 as a result of the performance adjustment operation.

In an embodiment, the environment module 11 collects the actual frame speed through application programming interface (API) provided by the operating system, such as DirectX for Microsoft Windows, Metal or OpenGL for iOS, Vulkan or OpenGL for Android, etc., but the present disclosure is not limited thereto.

In an embodiment, the environment module 11 collects the actual performance through shell scripts or application programming interface provided by an operating system, such as PowerShell or Windows Management Instrumentation (WMI) for Microsoft Windows, Bash or Python scripts for Linux, AppleScript for macOS, etc., but the present disclosure is not limited thereto.

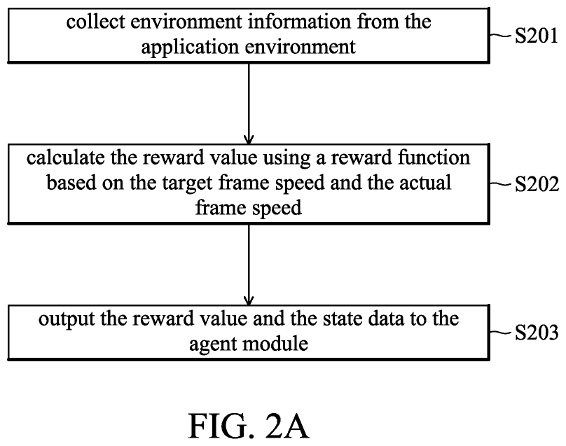

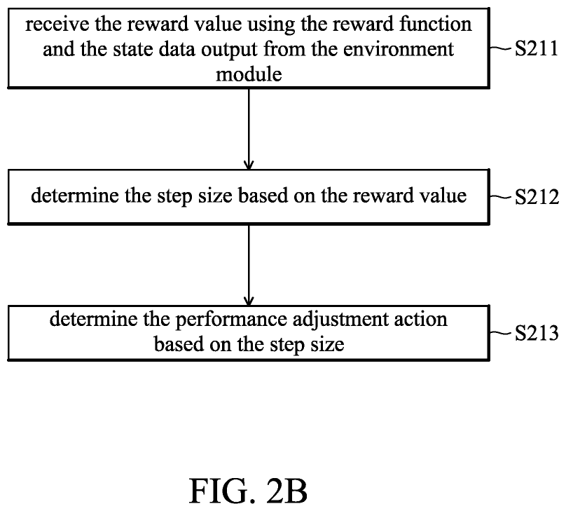

As briefly introduced, the closed-loop interaction between the environment module 11, the agent module 12, and the application environment 15 forms a continuous cycle of adaptation and optimization in response to changing conditions. More details regarding the operational behaviors of the environment module 11 and the agent module 12, will be described with reference to FIG. 2A and FIG. 2B.

FIG. 2A and FIG. 2B are the flow diagrams illustrating the adaptive control method adopted by the system 10, according to an embodiment of the present disclosure. FIG. 2A illustrates the steps S201-203 for the environment module 11 to perform, while FIG. 2B illustrates the steps S211-S214 for the agent module 12 to perform.

In step S201, the environment module 11 collects environment information 104 including a target frame speed, an actual frame speed, and an actual performance from the application environment 15. Then, the environment module 11 proceeds to step S202.

The mentioned target frame speed and actual frame speed refers to the desired speed for displaying consecutive image frames and the actual speed achieved in practice, respectively. Since the actual frame speed is affected by the interplay of various factors, there exists discrepancy between the target frame speed and the actual frame speed.

Furthermore, it should be appreciated that the frame speed can be represented in the form of frame rate (i.e., the frequency or rate at which consecutive image frames are generated and displayed) or frame time (i.e., the time that passes between each of the frames). The frame rate and the frame time are reciprocals of each other. If one is known, the other can be readily inferred based on the reciprocal relation. Therefore, the actual frame speed may include one or both of the actual frame rate and the actual frame time. Similarly, the target frame speed may include one or both of the target frame rate and the target frame time.

The mentioned actual performance refers to the average computing performance of the application environment 15 during the generation of the last frame, as denoted by the

$$AP = \frac{{\int }_{t = i}^{j} PERF ( t ) dt}{FT\_LF} ,$$

formula in which AP stands for the actual performance, PERF( ) stands for computing performance as a function of time, t stands for time, i and j respectively stands for the start and end times of the last frame, and FT_LF stands for the frame time of the last frame. Typically, the computing performance is indicated by clock rate, namely the frequency at which the clock generator of a processor can generate pulses, but the present disclosure is not limited thereto. In some alternative implementations, the computing performance can be measured by metrics such as instructions per cycle (IPC), throughput, floating-point operations per second (FLOPS), or other benchmarks specific to the processor's architecture.

In step S202, the environment module 11 calculates the reward value 102 using a reward function based on the target frame speed and the actual frame speed. Then, the environment module 11 proceeds to step S203.

The mentioned reward function is a critical component of the RL-based system 10. It is a mathematical function that quantifies the desirability of the actions determined by the agent module 12 in the given state of the application environment 15, which is derived from the environment information 104 including the target frame speed, the actual frame speed, and the actual performance. The environment module 11 uses the reward value 102 to provide a numerical signal to the agent module 12, guiding the agent module 12 to make better decisions over time. In principle, the reward function is designed to produce a higher reward value 102 for desirable states of the application environment 15 in which the discrepancy between the target frame speed and the actual frame speed is smaller, and to produce a lower reward value 102 for undesirable states in which the discrepancy between the target frame speed and the actual frame speed is bigger. Without departing from this principle, embodiments of the present disclosure are not limited to a particular design of the reward function.

In an embodiment, the reward function uses a distance measure, such as Euclidean distance, squared Euclidean distance, or Minkowski distance, to evaluate the discrepancy between the target frame rate and the actual frame rate. In a preferred embodiment, the distance measure is absolute distance. More specifically, the reward value 102 is the opposite number of the absolute value of the difference between the target frame rate and the actual frame rate, as denoted by the formula RWV=−|TFR−AFR|, in which RWV stands for the reward value 102, TFR stands for the target frame rate, and the AFR stands for the actual frame rate.

In step S203, the environment module 11 outputs the reward value 102 and the state data 101 to the agent module 12. The state data 101 includes the actual frame speed and the actual performance, indicating the current state of the application environment 15.

Please refer to FIG. 2B. In step S211, the agent module 12 receives the reward value using the reward function 102 and the state data 101 output from the environment module 11. Then, the agent module 12 proceeds to step S212.

In step S212, the agent module 12 determines the step size based on the reward value. Then, the agent module 12 proceeds to step S213.

In step S213, the agent module 12 determines the performance adjustment action to take based on the step size.

The mentioned step size represents the extent that the agent module 12 decides to adjust the computing performance. A larger step size means that the decision (i.e., the performance adjustment action 103) of the agent module 12 will make more significant adjustments to the computing performance. On the other hand, a smaller step size results in more cautious adjustments.

In principle, the step size should be an increasing function with respect to the discrepancy between the target frame speed and the actual frame speed. This means that as the difference between the target and actual frame speeds increase, the step size should also increase. The goal is to enable the agent module to make more substantial adjustments when there is a larger deviation from the desired frame speed, allowing for faster convergence towards the target frame speed. Without departing from this principle, embodiments of the present disclosure are not limited to a particular design of the step size calculation. Furthermore, as previously discussed, the frame speed can be represented in the form of frame rate (i.e., the frequency or rate at which consecutive image frames are generated and displayed) or frame time (i.e., the time that passes between each of the frames). Therefore, either target and actual frame time or speed can be used to calculate the step size.

In an embodiment, the agent module determines the step size through optimizing the learning rate based on the reward value and calculating the step size based on the learning rate, the target frame speed, and the actual frame speed.

The mentioned learning rate is a parameter directly affecting the step size, that is, the extent that the agent module 12 decides to adjust the computing performance. A higher learning rate means the agent modules 12 will quickly adapt to new information, but it may also be more sensitive to noise and fluctuations in the application environment 15. On the other hand, a lower learning rate makes the agent module 12 more stable and conservative, but it may take longer to learn and adapt to changes in the application environment 15. The objective for the optimization of the learning rate is to maximize the reward value 102 received during the interactions with the application environment 15 and the environment module 11. The algorithm used for the optimization can be Q-learning, Deep Q Network (DQN), Proximal Policy Optimization (PPO), or Actor-Critic methods, but the present disclosure is not limited thereto. These optimization algorithms allow the agent module 12 to learn and update its decision-making policy based on the collected rewards (i.e., the reward values 102) and the observed states (i.e., the state data 101) of the environment. By iteratively exploring different actions and adjusting the policy to maximize rewards, the agent module 12 can improve its decision-making and adapt to changing conditions in the application environment. 15

In an embodiment, the agent module 12 determines the step size through multiplying the learning rate by the discrepancy between the target frame time and the actual frame time, as denoted by the formula STPSZ=LR×|TFT−AFT|, in which STPSZ stands for the step size, LR stands for the learning rate, TFT stands for the target frame time, and AFT stands for the actual frame time.

It should be noted that the performance adjustment action determined by the agent module 12 merely serves as a policy decision to convey the target performance level and/or the target frame speed to the application environment 15. It does not guarantee that the application environment 15 will definitively achieve and sustain the target performance level and/or the target frame speed during the generation of the next frame. The effectiveness of the performance adjustment relies on the interplay of various factors and the dynamics of the system. As such, the policy decision (i.e., the performance adjustment action) of the agent module 12 seeks to guide the behavior of the application environment 15, but the final outcome, namely the next actual performance that will be collected by the environment module 11, may vary depending on the real-time conditions and constraints within the environment.

Upon receiving the performance adjustment action, the application environment 15 executes a performance adjustment operation in response to the performance adjustment action. The performance adjustment operation is the operation actually executed by the application environment 15, seeking to achieve the target performance level directly or indirectly specified by the agent module 12 through the performance adjustment action.

In an embodiment, the performance adjustment operation includes adjusting computing performance through setting a new target frame speed. In other words, the application environment 15 seeks to achieve the target performance level through adjusting the target frame speed, which can be the target frame rate or the target frame time. As the target frame rate and computing performance are positively correlated, increasing (decreasing) the target frame rate can lead to a corresponding increase (decrease) in computing performance. Conversely, since the target frame time and computing performance are inversely related, increasing (decreasing) the target frame time can lead to a corresponding decrease (increase) in computing performance. Theoretically, the correlation between the computing performance and the target frame time can be denoted by the formula

$$TCP = \frac{{\int }_{t = i}^{j} PERF ( t ) dt}{TFT} + δ ,$$

in which TCP stands for the theoretical actual performance of the next frame, PERF( ) stands for computing performance as a function of time, t stands for time, i and j respectively stands for the start and end times of the last frame, TFT stands for the target frame time, and δ stands for an offset value affected by factors other than the target frame time.

In an embodiment, the performance adjustment action is associated with the target frame speed. More specifically, the agent module specifies how the target frame speed should be adjusted, that is, specifies a new target frame speed for the application environment 15 to achieve. Additionally, the agent module 12 is further configured to calculate the new target frame speed through incrementing the target frame speed by the step size, as denoted by the formula NTFS=TFS+STPSZ, in which NTFS stands for the new target frame speed, TFS stands for the target frame speed, and STPSZ stands for the step size. As previously described that the target frame speed and computing performance are correlated, it should be appreciated that the performance adjustment action, which specifies the new target frame speed, can also be regarded as indirectly specifying the target performance level, namely the desired computing performance during the generation of the next frame.

In an embodiment, the performance adjustment action is associated with a target performance level. As previously discussed, the target performance level is dependent on the step size. Additionally, the actual performance, namely the average computing performance of the application environment 15 during the generation of the last frame, is also taken into consideration when determining the performance adjustment action. More specifically, the agent module 12 is further configured to calculate the target performance level through multiplying the actual performance by the step size, as denoted by the formula TP=AP×STPSZ, in which TP stands for the target performance level, AP stands for the actual performance, and STPSZ stands for the step size. Moreover, the agent module 12 is further configured to determine the new target frame speed through looking up a mapping table that records mappings between the target performance level and the target frame speed. The mapping table, which may also be referred to as the “lookup table”, can be in the form of an array of data that maps the target performance level to the target frame speed, thereby approximating a mathematical function. Given a certain target performance level, the corresponding target frame speed can be retrieved from the table through a lookup operation. The determination of the new target frame speed may further involve interpolation, in case the specific target performance level falls between two entries in the table. Interpolation allows for estimating the appropriate target frame speed based on the surrounding data points in the mapping table, ensuring a smooth transition between performance levels.

The RL-based adaptive control techniques provided in the present disclosure offers several benefits for computing performance optimization. Firstly, it enables adaptability by continuously adjusting the system's performance based on changing conditions and requirements. Secondly, it empowers the system to make autonomous decisions without relying on predefined rules or manual intervention, leading to more efficient and effective control. Thirdly, the system can optimize its performance by exploring different strategies and configurations, finding the best approach for a given task. Additionally, the learned policies can generalize to handle various workloads and scenarios, making the system versatile and responsive in diverse environments. Moreover, the continuous learning capability allows the system to improve its performance control over time. Overall, this approach provides intelligent and dynamic computing performance control in a changing computing environment.

The above paragraphs are described with multiple aspects. Obviously, the teachings of the specification may be performed in multiple ways. Any specific structure or function disclosed in examples is only a representative situation. According to the teachings of the specification, it should be noted by those skilled in the art that any aspect disclosed may be performed individually, or that more than two aspects could be combined and performed.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A reinforcement learning-based system for adaptively controlling computing performance, comprising:
an environment module, configured to collect environment information including target frame speed, actual frame speed, and actual performance from an application environment, calculate a reward value using a reward function based on the target frame speed and the actual frame speed, and output the reward value and state data that includes the actual frame speed and the actual performance; and
an agent module, configured to receive the reward value and the state data output from the environment module, determine a step size based on the reward value, and determine a performance adjustment action to take based on the step size;
wherein the application environment executes a performance adjustment operation in response to the performance adjustment action;
wherein the actual frame speed includes one or both of an actual frame rate and an actual frame time, and the target frame speed includes one or both of a target frame rate and a target frame time.

2. The system as claimed in claim 1, wherein the agent module determines the step size through optimizing a learning rate based on the reward value and calculating the step size based on the learning rate, the target frame speed, and the actual frame speed.

3. The system as claimed in claim 2, wherein the agent module determines the step size through multiplying the learning rate by a first discrepancy between the target frame time and the actual frame time.

4. The system as claimed in claim 2, wherein the reward function uses a distance measure to evaluate a second discrepancy between the target frame rate and the actual frame rate.

5. The system as claimed in claim 4, wherein the distance measure is absolute distance.

6. The system as claimed in claim 1, wherein the performance adjustment operation includes adjusting computing performance through setting a new target frame speed.

7. The system as claimed in claim 6, wherein the performance adjustment action is associated with the target frame speed; and
wherein the agent module is further configured to calculate the new target frame speed through incrementing the target frame speed by the step size.

8. The system as claimed in claim 6, wherein the performance adjustment action is associated with target performance level; and
wherein the agent module is further configured to calculate the target performance level through multiplying the actual performance by the step size, and to determine the new target frame speed through looking up a mapping table that records mappings between the target performance level and the target frame speed.

9. The system as claimed in claim 1, wherein the environment module collects the actual frame speed through application programming interface provided by an operating system.

10. The system as claimed in claim 1, wherein the environment module collects the actual performance through shell scripts or application programming interface provided by an operating system.

11. An adaptive control method, for use in a reinforcement learning-based system comprising an environment module and an agent module, the method comprising the following steps for the environment module to perform:
collecting environment information including target frame speed, actual frame speed, and actual performance from an application environment;
calculating a reward value using a reward function based on the target frame speed and the actual frame speed; and
outputting the reward value and state data that includes the actual frame speed and the actual performance to the agent module;
wherein the actual frame speed includes one or both of an actual frame rate and an actual frame time, and the target frame speed includes one or both of a target frame rate and a target frame time; and
wherein the method further comprises the following steps for the agent module to perform:
receiving the reward value and the state data output from the environment module;
determining a step size based on the reward value; and
determining a performance adjustment action to take based on the step size;
wherein the application environment executes a performance adjustment operation in response to the performance adjustment action;

12. The method as claimed in claim 11, wherein the step of determining the step size comprises:
optimizing a learning rate based on the reward value; and
calculating the step size based on the learning rate, the target frame speed, and the actual frame speed.

13. The method as claimed in claim 12, wherein the step of determining the step size further comprises:
multiplying the learning rate by a first discrepancy between the target frame time and the actual frame time.

14. The method as claimed in claim 12, wherein the reward function uses a distance measure to evaluate a second discrepancy between the target frame rate and the actual frame rate.

15. The method as claimed in claim 14, wherein the distance measure is absolute distance.

16. The method as claimed in claim 11, wherein the performance adjustment operation includes adjusting computing performance through setting a new target frame speed.

17. The method as claimed in claim 16, wherein the performance adjustment action is associated with the target frame speed; and
wherein the method further comprises the following steps for the agent module to perform:
calculating the new target frame speed through incrementing the target frame speed by the step size.

18. The method as claimed in claim 16, wherein the performance adjustment action is associated with a target performance level, and the method further comprises the following steps for the agent module to perform:
calculating the target performance level through multiplying the actual performance by the step size; and
determining the new target frame speed through looking up a mapping table that records mappings between the target performance level and the target frame speed.

19. The method as claimed in claim 11, wherein the method further comprises the following steps for the environment module to perform:
collecting the actual frame speed through application programming interface provided by an operating system.

20. The method as claimed in claim 11, wherein the method further comprises the following steps for the agent module to perform:
collecting the actual performance through shell scripts or application programming interface provided by an operating system.
